(19) United States
(12) Patent Application Publication
(10) Pub. No.: US 2025/0215960 A1
(43) Pub. Date: Jul. 3, 2025

(54) ORTHOGONAL PROJECTION MECHANISM

(71) Applicant: Chesley Kraniak, Arlington, TX (US)

(72) Inventor: Chesley Kraniak, Arlington, TX (US)

(21) Appl. No.: 19/004,416

(22) Filed: Dec. 29, 2024

Related U.S. Application Data
(60) Provisional application No. 63/615,865, filed on Dec. 29, 2023.

(51) Int. Cl. F16H 21/40

(52) U.S. Cl. CPC F16H 21/40

(57) ABSTRACT

Two straight-line mechanisms and a pantograph mechanism may be connected and laid out in a particular way. When assembled in the given fashion, the linkage may cause a displacement delivered to one of its joints to be reflected in another of its joints, with one Cartesian dimension of the input motion removed. For instance, a circular motion of the input link will become a sinusoidal motion of the output link. Since the linkage can be driven in reverse, it also may serve to drive motion on one linear axis without constraining motion on a second axis.

### CROSS-REFERENCE TO RELATED APPLICATION

The present Application is a non-provisional of, and claims priority to, U.S. Patent Application No. 63/615,865 filed Dec. 29, 2023, the disclosure of which is incorporated by reference in its entirety.

### FIELD OF THE DISCLOSURE

The present disclosure generally relates to linkage mechanisms, and more particularly mechanisms which may produce useful types of mechanical constraints in the context of integration into a larger system.

### BACKGROUND

Mechanisms for performing mathematically useful operations are somewhat sparse. A few are known, and they can produce effects including (non-sinusoidal) oscillating motion, straight-line motion, and constant-factor multiplication of motion, but several important effects are needed to produce an environment that can be utilized by more conventional engineering and mathematical methods. The general mathematical effect that the linkage produces is an orthogonal projection of a point onto a line. In reverse, the linkage produces a constraint along one linear axis of a point's motion while leaving the orthogonal axis unconstrained. The orthogonal projection of a point on a spinning circle onto a line is a point moving sinusoidally along the line; thus, this mechanism trivially produces sinusoidal motion by constraining the input to move along a circular path at a constant angular velocity. These properties allow linkage engineers access to sinusoidal motion without the need to introduce sliding mechanisms (such as Scotch yokes), allowing designs which only contain links and rotating joints. Sinusoidal motion can be further used with more advanced techniques that rely on manipulation of trigonometric functions (e.g., Fourier analysis, mathematical combinations of trigonometric functions). The projection function allows engineers to treat X and Y axes separately, or to filter one axis completely out of a motion, which allows further designs that usefully employ such an effect. The inverse function that allows one axis to be constrained can be used to construct a 2D position from two 1D positions, for instance; combining this with the ability to manipulate 1D positions mathematically, many very complex paths can be assembled through this dimensional reassembly technique. Expansion of the ability for linkages to perform mathematical operations reduces the degree to which engineers must rely on complex electronics to create necessary motions.

### SUMMARY

Embodiments of the present disclosure may provide two straight-line mechanisms and a pantograph mechanism connected and laid out in a particular way. When assembled in the given fashion, the linkage may cause a displacement delivered to one of its joints to be reflected in another of its joints, with one Cartesian dimension of the input motion removed. For instance, a circular motion of the input link will become a sinusoidal motion of the output link. Since the linkage can be driven in reverse, it also may serve to drive motion on one linear axis without constraining motion on a second axis.

Embodiments of the present disclosure may provide a device comprising a pantograph linkage, with both ends constrained to move in a straight-line motion. The pantograph linkage may use ratios such that the point lying along the line of motion is centered between the ends. The straight-line motion constraint may be accomplished using straight line motion mechanisms, such as Peaucellier-Lipkin (also referred to as “Peaucellier” herein) linkages, B-SLM linkages, slider mechanisms, or any other device capable of constraining motion to a straight line, and the two ends may be constrained with either the same straight line motion mechanism or two different mechanisms. The straight-line motion mechanisms may be B-SLM linkages. The B-SLM linkages may be bent at a non-zero angle. The pantograph joint lying off the line of motion may be constrained to move in a circle. The pantograph joint lying off the line of motion may be constrained to move in any arbitrary two-dimensional motion, and the pantograph joint lying along the line of motion may be either unconnected or constrained to drive or output to another device. The pantograph joint lying along the line of motion may be constrained or driven by another device, and the motion of the pantograph joint lying off the line of motion may be constrained in its motion parallel to the direction of the line of motion. The motion of the joint lying off the line of motion along the direction perpendicular to the line of motion may be either unconstrained or constrained by another device.

### BRIEF DESCRIPTION OF THE DRAWINGS

For a more complete understanding of this disclosure, reference is now made to the following description, taken in conjunction with the accompanying drawings, in which:

FIG. 1 depicts a pantograph mechanism according to an embodiment of the present disclosure;

FIG. 2 depicts an orthographic projection mechanism according to an embodiment of the present disclosure;

FIG. 3 depicts constraints realized by B-SLMs and by the Peaucellier-Lipkin linkage according to embodiments of the present disclosure;

FIG. 4 depicts a “butterfly” straight line mechanism (B-SLM) according to an embodiment of the present disclosure;

FIG. 5 depicts a bent B-SLM according to an embodiment of the present disclosure; and

FIGS. 6 and 7 depict an angled view and a side view of a prototype according to an embodiment of the present disclosure.

### DETAILED DESCRIPTION

Embodiments of the present disclosure may provide two straight-line mechanisms and a pantograph mechanism connected and laid out in a particular way. When assembled in the given fashion, the linkage may cause a displacement delivered to one of its joints to be reflected in another of its joints, with one Cartesian dimension of the input motion removed.

A linkage is an assembly of rigid structures which are attached to each other in a manner such that the structures may move in a geometrically desirable way. A linkage may be constrained so that no motion can occur between any of its internal rigid bodies, and when this is done, it may resemble a truss, or even an arbitrary structure.

Commonly, linkages are made from combinations of rods, plates, and pins. Rods are rigid straight elements with pinnable holes on either end, or optionally, at positions between either end. Plates are rigid elements with three or more pinnable holes at various locations, where the holes do not all lie along a single straight line. Pins may be used to connect rods and plates at locations called joints, and the pins permit the rods and plates to rotate.

Many other ways of realizing a linkage exist. The holes in the rods or joints may be enhanced with bearings, or pins may be integrated into rods or plates. Linkage configurations, known as flexures, have no pins at all, instead producing a rotationally compliant connection by introducing a deliberately weak point designed for the mechanism to bend at. In all of these cases, the fundamental geometry of the link remains the same, and a practitioner skilled in the art will recognize that linkages may be trivially created using various combinations of these implementation choices.

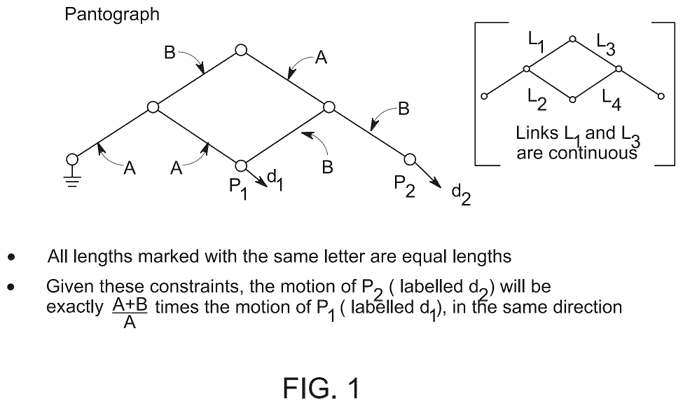

An example of a pantograph mechanism is shown in FIG. 1 according to an embodiment of the present disclosure. It should be appreciated that the lengths marked with the same letter may have equal lengths. Given the constraints, the motion of P₂ (labeled d₂) may be A+B/A times the motion of P₁ (labeled d₁) in the same direction. Further, links L₁ and L₃ are continuous in that they extend from the end points to the point in the middle where L₁ and L₃ meet; that is, the point in their middles is not a point that breaks L₁ and L₃ in two. As shown, the left-most joint in the mechanism may be fixed to a point, and either joint P₁ or P₂ may be moved. If point P₁ is moved, then point P₂ may move along a path with the same shape, but scaled by some scale factor that is dependent on the ratios of the lengths of the rods. This may produce a scaled copying effect.

In a standard pantograph mechanism, the point P₁ may be constrained by the geometry of the mechanism to lie along a line between the left-most joint and the joint at P₂, and the ratios of the links may be modified to cause joint P₁ to be closer to either the left-most joint or P₂, depending on the ratios selected. As an example, in order for such a pantograph to achieve a positioning of joint P₁ precisely halfway between the left-most joint and P₂, the links L₁, L₂, L₃, and L₄ as depicted in FIG. 1 may be designed with ratios such that L₁ and L₃ are equal lengths, L₂ and L₄ are equal lengths, and L₂ (or L₄) may be half the length of L₁ (or L₃), and joints may be located halfway along L₁ and L₃ in an embodiment of the present disclosure.

Alternative topologies to the standard pantograph mechanism may exist which produce similarly constrained motions between similarly located points by varying the lengths of the links and the placements of the joins along the two long links L₁ and L₃. A practitioner skilled in the art will recognize many alternative topologies which are substantially similar, requiring only trivial modifications to the original mechanism to achieve a similar desired motion.

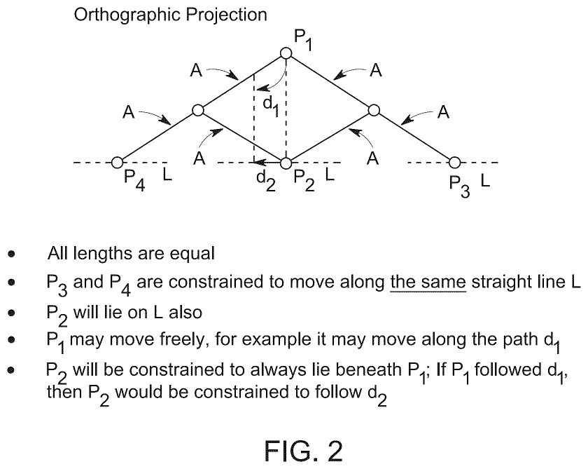

FIG. 2 depicts an orthographic projection mechanism according to an embodiment of the present disclosure. The mechanism may contain a pantograph mechanism, except that the pantograph may not have a single end fixed to a point as in the standard mechanism, but rather both ends may be constrained with straight-line constraints. The straight-line constraints are collinear. As depicted herein, the lengths may be equal, and P₃ and P₄ may be constrained to move along the same straight-line L. P₂ also may lie on the same straight line. P₁ may move freely. For example, it may move along the path d₁. P₂ may be constrained to always lie beneath P₁. If P₁ followed d₁, then P₂ may be constrained to follow d₂.

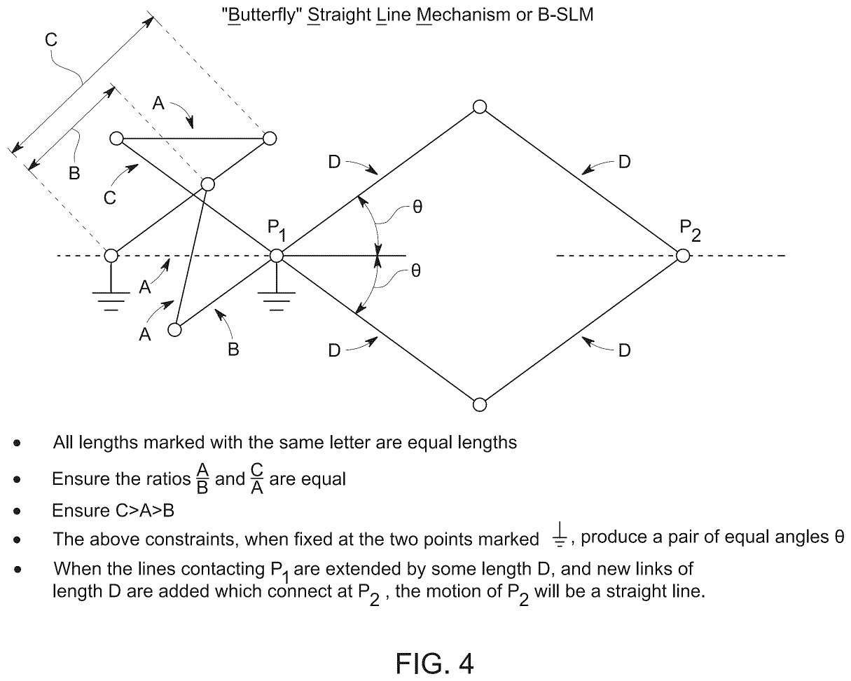

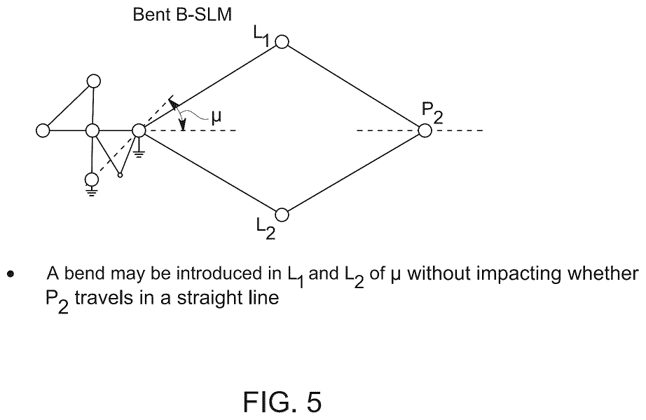

In an embodiment of the present disclosure, these constraints may be achieved using two “butterfly” straight line mechanisms (hereafter B-SLMs) (see FIGS. 4 and 5). More specifically, FIG. 4 depicts a B-SLM wherein the lengths marked with the same letter are equal lengths. The ratios of A/B and C/A may be equal, and C may be greater than A, and A may be greater than B. The above constraints, when fixed at the two points with 3 horizontal lines (i.e., a ground symbol representing a fix constraint) may produce a pair of equal angles. When the lines contacting P₁ are extended by the same length D, and new lengths of length D are added which connect at P₂, the motion of P₂ may be a straight line. FIG. 5 depicts a bent B-SLM according to an embodiment of the present disclosure. As depicted herein, a bend may be introduced in L₁ and L₂ without impacting whether P₂ travels in a straight line. In other embodiments, they may be accomplished with Peaucellier-Lipkin linkages, or with Sarrus linkages, or by attaching rollers and pressing the system flush against a flat surface, or by any other means of achieving motion constrained to move along a single line.

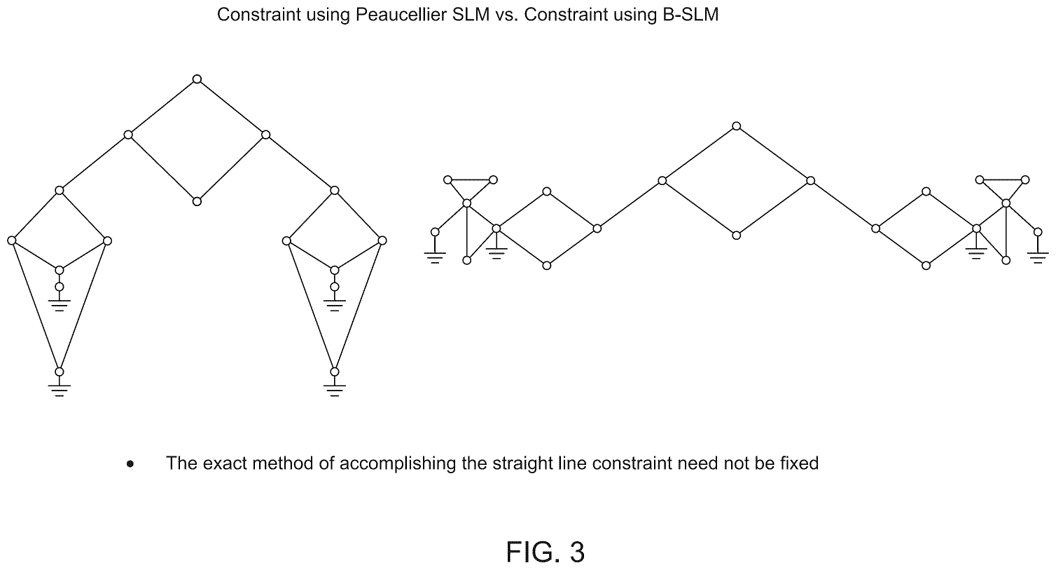

Many means exist to constrain the motion of a joint in a linkage to traveling along a straight line. One such means is shown in FIG. 3, where the two constraints are realized by B-SLMs. Another is shown in FIG. 3, where the two constraints are realized by the Peaucellier-Lipkin linkage. The constraints need not be realized by linkages; they may be realized by gears, slides, or any other means to achieve a straight-line motion constraint. It also should be appreciated that the exact method of accomplishing the straight-line constraint need not be fixed.

When this linkage is constrained, a line drawn between joints P₁ and P₂ may be perpendicular to the straight-line motion of the constrained joints P₃ and P₄, and the joint P₂ itself will lie along the line. If the joint P₁ moves in the direction of the straight-line constraint, then joint P₂ may move with it such that the joints remain aligned along a line perpendicular to the straight-line constraint. If the joint P₁ moves in a direction perpendicular to the straight-line constraint, then the joint P₂ will remain stationary since it remains coincident with the straight-line constraint between joints P₃ and P₄. Alternatively, the joint P₂ may be moved in the direction of the straight-line constraint, and the joint P₁ may move such that it continues to remain in line with joint P₂ along a line perpendicular to the direction of the straight-line constraints, although the motion of joint P₁ perpendicular to the motion of P₂ may be indeterminate in this case.

When joint P₁ is further constrained by a link such that one end is pinned to joint P₁ and the other end is fixed, joint P₁ may move in a circular motion. Such a constraint may also be accomplished by attaching joint P₁ to a wheel or gear, or by attaching joint P₁ to a crankshaft, or by any other means of constraining the motion of a point in a machine to lie along a circular path. In this case, if joint P₁ is rotated at a constant angular velocity, the path of joint P₁ may vary sinusoidally. The intent is that joints P₁ and P₂ of this mechanism may be connected to other linkages or mechanical systems to form a larger mechanical combination.

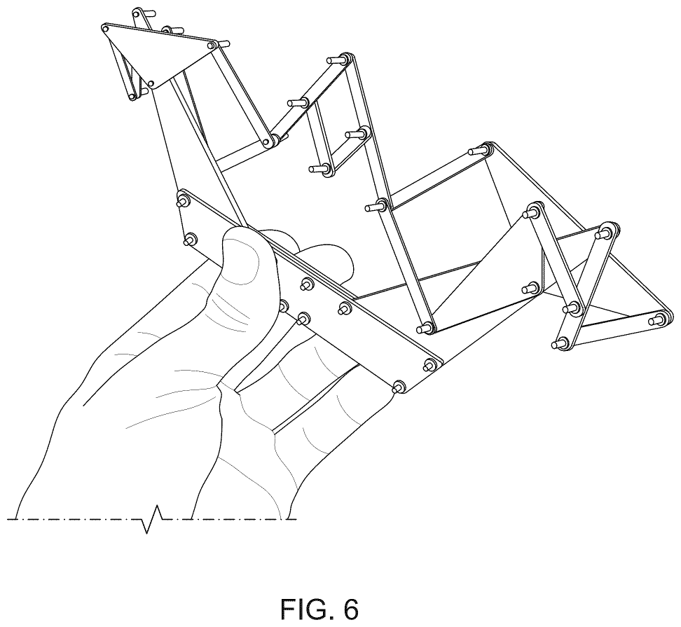

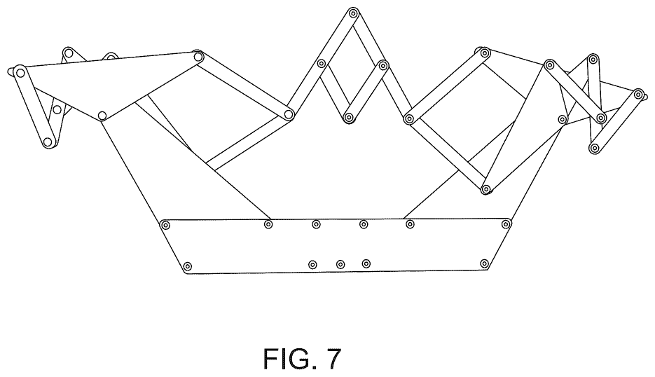

FIGS. 6 and 7 depict an angled view and a side view of a prototype according to an embodiment of the present disclosure.

The straight-line mechanisms that may comprise the linkage may be substituted by any other suitable mechanism that produces straight lines. These could be simple slider mechanisms, other straight-line linkages (e.g., Peaucellier-Lipkin linkages, Sarrus linkages), or mixed combinations of such linkages.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A device comprising:
a pantograph linkage with both ends constrained to move in a straight-line motion.

2. The device of claim 1, wherein the pantograph linkage uses ratios such that the point lying along the line of motion is centered between the ends.

3. The device of claim 1, wherein the straight-line motion constraint is accomplished using straight line motion mechanisms selected from the group comprising:
Peaucellier linkages, B-SLM linkages, slider mechanisms, or any other device capable of constraining motion to a straight line,
wherein the two ends are constrained with either the same straight line motion mechanism or two different mechanisms.

4. The device of claim 3, where the straight-line motion mechanisms are B-SLM linkages.

5. The device of claim 4, where the B-SLM linkages are bent at a non-zero angle.

6. The device of claim 1, where the pantograph joint lying off the line of motion is constrained to move in a circle.

7. The device of claim 1, wherein the pantograph joint lying off the line of motion is constrained to move in any arbitrary two-dimensional motion, and
wherein the pantograph joint lying along the line of motion is either unconnected or constrained to drive or output to another device.

8. The device of claim 1, wherein the pantograph joint lying along the line of motion is constrained or driven by another device,
wherein the motion of the pantograph joint lying off the line of motion is constrained in its motion parallel to the direction of the line of motion, and
wherein the motion of the joint lying off the line of motion along the direction perpendicular to the line of motion may be either unconstrained or constrained by another device.

9. An orthogonal projection mechanism comprising:
two straight-line mechanisms; and
a pantograph mechanism, wherein the two straight-line mechanisms and the pantograph mechanism are connected and linked resulting in a linkage that causes a displacement delivered to one of its joints to be reflected in another of its joints, with one Cartesian dimension of an input motion removed.

10. The orthogonal projection mechanism of claim 9, wherein a circular motion of an input link becomes a sinusoidal motion of an output link.

11. The orthogonal projection mechanism of claim 9, wherein the linkage is driven in reverse.

12. The orthogonal projection mechanism of claim 11, wherein the linkage drives motion on one linear axis without constraining motion on a second axis.
